(19) United States
(12) Patent Application Publication
(10) Pub. No.: US 2025/0198878 A1
(43) Pub. Date: Jun. 19, 2025

(54) METHOD FOR ESTIMATING TIME BETWEEN WIRE RUPTURES APPLICABLE TO TENSILE ARMORS OF FLEXIBLE PIPES BY FATIGUE MECHANISM

(71) Applicant: PETRÓLEO BRASILEIRO S.A. - PETROBRAS, Rio de Janeiro (BR)

(72) Inventors: GEORGE CARNEIRO CAMPELLO, Rio de Janeiro (BR); RODOLFO FIGUEIRA DE SOUZA, Rio de Janeiro (BR); TIAGO BRUN COSER, Rio de Janeiro (BR)

(73) Assignee: PETRÓLEO BRASILEIRO S.A. - PETROBRAS, Rio de Janeiro (BR)

(21) Appl. No.: 18/981,358

(22) Filed: Dec. 13, 2024

(30) Foreign Application Priority Data
Dec. 15, 2023 (BR) 1020230264743

(51) Int. Cl. G01M 5/00

(52) U.S. Cl. CPC G01M 5/0033; G01M 5/0025

(57) ABSTRACT

The present invention discloses a method for estimating the time between ruptures applicable to tensile armor wires that are components of flexible pipes by a fatigue mechanism, comprising: receiving data on the flexible pipe; calculating, based on the data on the flexible pipe, by mathematical modeling, the curve of accumulated fatigue damage (AFD) vs. % of broken wires; calculating the time interval required for the number of broken wires to evolve from the number of broken wires at the time of inspection to the maximum permitted number of broken wires; and defining the interval between inspections. With this, it becomes possible to reassess the viability of flexible pipes at level 3 and, eventually, promote an extension in their lifespan, reducing operating costs by avoiding unnecessary replacements.

### FIELD OF THE INVENTION

The present invention is part of the field of methodologies for calculating the fatigue life of flexible pipes, acting for the integrity management of flexible risers. More specifically, the present invention relates to a method for estimating the time between wire ruptures in tensile armors of flexible pipes by means of fatigue.

### BACKGROUND OF THE INVENTION

Unbonded flexible pipes play a vital role in the connection between the subsea well and the production platform, allowing the efficient transfer of fluids such as hydrocarbons, gas and water between the seabed and the surface. Unbonded flexible pipes are composed of a sequence of layers of metallic, polymeric and composite materials that perform specific structural functions. Among the metallic layers, the tensile armors are composed of multiple wires that resist the traction loads of the pipe.

In this sense, it is worth highlighting that the lifespan of flexible pipes is influenced by several factors, with fatigue of tensile armor being one of the main challenges. In these pipes, the constant movement of waves, sea currents and wind, creates cyclical stresses, leading to structural fatigue over time. These loading and unloading cycles can result in microcracks and their eventual inoperability.

To ensure safety and extend the lifespan of flexible pipes, continuous monitoring strategies, fatigue modeling, regular inspections and preventive maintenance are essential. The process of calculating the fatigue life of flexible pipes involves several uncertainties, so the safety factors (FS) involved in the analysis are high.

For example, the safety factor recommended by the international standards API Spec 17J and API RP 17B for fatigue of flexible risers is 10. In other words, the life obtained by the traditional method must be at least 10 times greater than the life required by the project. Due to all the probabilistic uncertainties inherent in the maritime environment (waves, currents and winds), the fact that a riser has FS<10 does not necessarily mean that it is in an unsafe condition.

A flexible riser can operate with a certain limit of broken tensile armor wires, however, one of the biggest challenges for managing the integrity of these structures is knowing how the progressive rupture of the wires occurs up to an admissible limit.

Currently, the following levels are considered for analyzing the effect of fatigue on flexible pipes, namely:
Level 1: Conventional fatigue analysis of flexible pipes considering the design conditions. Using numerical or analytical simulators, the entire life cycle of the pipe is reproduced during the expected period of operation and the accumulated fatigue damage is calculated. In order to meet the safety factor, the accumulated fatigue damage (AFD) must be 10 times less than the failure damage, as recommended by API Spec 17J and API RP 17B standards;
Level 2: If the Level 1 analysis does not result in a lifespan with a safety factor equal to or greater than 10, the type of analysis called Level 2 is used. This type of analysis is based on structural reliability calculations together with a specific risk analysis for the case being evaluated. The structural reliability analysis estimates the increase in the probability of failure that serves as input for categorizing the failure frequencies in a risk matrix.

Before the invention, there was no method for estimating the time between progressive ruptures of tensile armor wires in flexible pipes. In other words, there was no alternative for managing fatigue integrity other than the traditional fatigue method (level 1) or structural reliability (level 2). Therefore, if neither of the two approaches presented viable results, the operational continuity of the pipes had no technical support and, therefore, there was no possibility of extending their life.

In this sense, the present invention shows a level 3 method to support a possible extension of the life of flexible pipes considering the fatigue mechanism when there is no technical support for the continuity of the pipeline operation according to the methodologies shown in the previous levels (levels 1 and 2).

### STATE OF THE ART

Some documents from the state of the art disclose technologies that fit the same objective as the present invention, in which, however, unresolved deficiencies still persist.

The article entitled “A METHODOLOGY TO PREDICT THE REMAINING FATIGUE LIFE OF A FLEXIBLE PIPE WITH BROKEN TENSILE ARMOR WIRES” discloses an approach to predict the remaining lifespan of flexible pipes with damage to their tensile armor wires. This approach is based on a previous approach proposed to calculate the fatigue life of intact flexible pipes. Based on results of theoretical and experimental investigations, the previously proposed expressions were modified to take into account damage to the tensile armor wires of these structures. In addition, the calculation of the fatigue life was also modified to consider results of inspections on these pipes, thus allowing the estimation of the remaining lifespan of the pipe.

Document CN 106202913 B describes a method for assessing time-related creep fatigue damage that comprises the steps of: performing repeated experiments on a target material to acquire a necessary set of parameters; according to the set of parameters, calculating to obtain the creep damage of each cycle and the fatigue damage of each cycle; calculating the accumulated creep damage of a cycle n and the accumulated fatigue damage of cycle n; according to the accumulated creep damage of cycle n and the accumulated fatigue damage of cycle n, drawing an interactive creep fatigue damage diagram; and combining the interactive creep fatigue damage diagram and at least one damage accumulation rule, evaluating a real-time damage accumulation condition of the target material.

Document BR 102013007957 B1 describes a monitoring system, primarily aimed at providing accurate information on the structural conditions of the wires in all layers of tensile armor of a flexible riser. The proposed technology accurately determines the occurrence of ruptures in the external and internal wires of the tensile armor of flexible pipes, making it possible to assess the risk of failure in the integrity of a riser structure.

Although the listed documents from the state of the art disclose methods for optimizing calculations of the lifespan of flexible pipes, none of them come close to the present invention, as they fail to describe alternatives that provide a level 3 approach, which supports the extension of the lifespan of the flexible pipe based on the estimate of the number of broken wires in the tensile armor, when the traditional fatigue approach or the structural reliability approach do not show viable results.

### BRIEF DESCRIPTION OF THE INVENTION

The present invention discloses a method for estimating the time between ruptures applicable to tensile armor wires that are components of flexible pipes by a fatigue mechanism, comprising: receiving data on the flexible pipeline; calculating, based on the data on the flexible pipeline, by mathematical modeling, the curve of accumulated fatigue damage (AFD) vs. % of broken wires; calculating the time interval required for the number of broken wires to evolve from the number of broken wires at the time of inspection to the maximum permitted number of broken wires; and defining the interval between inspections. With this, it becomes possible to reassess the viability of flexible pipes at level 3 and, eventually, promote an extension in their lifespan, reducing operating costs.

### BRIEF DESCRIPTION OF THE FIGURES

To assist in identifying the main features of the present invention, the FIGURE to which references are made is indicated.

FIG. 1 illustrates the structure of a typical unbonded flexible riser.

### DETAILED DESCRIPTION OF THE INVENTION

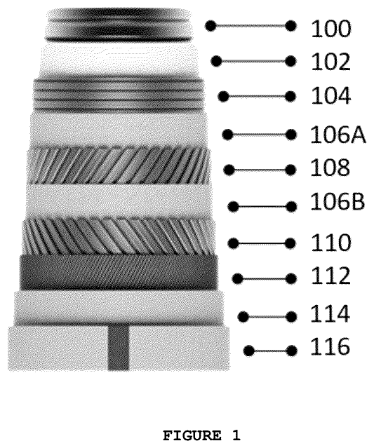

As can be seen in FIG. 1, a typical unbonded flexible riser is composed of the following structures: interlocked casing (100), internal polymeric layer (102), pressure armor (104), internal tensile armor (108), external tensile armor (110), high-strength tape (112), external polymeric layer (114) and external tensile polymeric layer (116). In addition, this type of riser also has two anti-friction layers (106A, 106B) between the armors.

The main function of tensile armor in an unbonded flexible riser is to provide structural strength and support to the riser, ensuring its ability to withstand stresses, pressures and mechanical movements during oil extraction operations. This armor is composed of high-strength wires made of materials such as aramid or steel alloys and is incorporated to ensure the stability and structural integrity of the riser.

These wires help distribute loads along the riser, providing support against external forces such as ocean movements, currents and pressures. They are essential for maintaining the flexibility of the riser, allowing it to move and adjust as subsea conditions change, while maintaining the strength required to support deepwater extraction operations.

However, intense and/or prolonged movement of these risers can generate a certain amount of structural wear and, consequently, the rupture of these tensile armor wires. In this sense, a flexible riser can operate with a certain limit of ruptured tensile armor wires, but one of the greatest challenges for managing the integrity of these structures is knowing how the progressive rupture of the wires occurs up to an admissible limit.

Therefore, the present invention consists of a method for determining the time between wire ruptures in the tensile armor of flexible pipes, wherein it is possible to support a possible extension of the life of such pipes considering the fatigue mechanism, assuming the following three levels:
Level 1: Conventional fatigue analysis of flexible pipes considering the design conditions. Through numerical or analytical simulators, the entire life cycle of the riser is reproduced during the expected period of operation and the accumulated fatigue damage is calculated (which is a life consumption counter). In order for the safety factor to be met, the accumulated fatigue damage (AFD) must be 10 times smaller than the failure damage;
Level 2: If the Level 1 analysis does not result in a useful life with a safety factor equal to or greater than 10, the type of analysis called Level 2 is used. This type of analysis is based on structural reliability calculations together with a specific risk analysis for the case evaluated. The structural reliability analysis estimates the increase in the probability of failure that serves as input for categorizing the failure frequencies in the risk matrix, and
Level 3: If the risk analysis performed at Level 2 has resulted in any non-tolerable scenario (NT), the Level 3 analysis can be performed. The objective of applying this level is to support the integrity management of flexible pipes in relation to fatigue.

Thus, considering that the flexible pipe did not obtain support at levels 1 and 2, the method proposed by the present invention has the following steps: starting operation and collection of data and information necessary for the analysis; calculating the fatigue damage associated with the admissible number of broken wires AFD (η_{adm}); calculating the time interval necessary for the number of broken wires to evolve from η_{I} to the admissible number η_{adm}; and calculating the extension of useful life and inspection frequency.

### Collection of Data and Information Required for Analysis

It is necessary to collect information/data that will serve as input for the analysis, with the following highlights:
Operational history: verification of operating time and operating conditions. The operating conditions under which the flexible pipe was exposed will define some aspects relevant to the other analysis activities.
Annual fatigue damage: based on the assessment of the operational history, a traditional fatigue analysis is performed to define the associated annual fatigue damage.
Diagnosis of the structural condition of the armor (number of broken wires—ηᵢ): based on an inspection carried out on the flexible pipe, the number of broken wires at the time of inspection is identified (ηᵢ).
Maximum number of broken wires allowed by the structure (η_{adm}): considering the operational loads, the calculation is performed to define the admissible number of broken wires (η_{adm}). This calculation is performed based on a methodology supported by results of full-scale experimental tests determined based on engineering studies that consider the resistance of the materials, operational history, safety factors and failure analyses, and its calculation is not part of the scope of the present invention.
   Calculation of Fatigue Damage Associated with the Permissible Number of Broken Wires AFD (η_{adm})

Using some mathematical modeling method, for example, logarithmic or polynomial, and considering, the maximum associated accumulated damage (AFD_{adm}) is established. The accumulated fatigue damage (AFD) is an indicator of fatigue life consumption, obtained from engineering calculations, considering the specifications of each riser, which predicts the occurrence of fatigue failure for the set of applied loads.

Then, a rupture evolution curve is generated (“AFD vs % of broken wires”), that is, an AFD function in relation to the number of broken wires.

Calculation of the Time Interval Required for the Number of Broken Wires to Evolve from ηᵢ to the Admissible Number η_{adm}

Once AFD_{adm} is defined and based on the specifications obtained, it is possible to calculate the time interval required for the number of broken wires to evolve from ηᵢ to the admissible number (η_{adm}), such that:

$${T}_{N \_ wires} = \frac{( AFD ( {η}_{adm} ) - AFD ( {η}_{i )} )}{AFD ( {η}_{i )} )} * \frac{{T}_{op}}{FS} * ( \frac{{\sum }_{1}^{n} {d}_{j} {T}_{j} / {T}_{op}}{{d}_{after inspection}} )$$

where:
Tₒₚ is the operating time until the inspection date, dⱼ is the annual damage with the respective stress curves (S-N) of each period (Tⱼ) before the inspection, d_{after inspection} is the annual damage with the S-N curve after the inspection, and FS is the safety factor (FS=10).

Alternatively, when ηᵢ is not previously known, this can be estimated from the rotation angle of the pipe, by means of a rotation curve, as known from the state of the art.

### Calculation of Useful Life Extension and Inspection Frequency

Since the time to reach AFD_{adm}, the useful life extension and inspection frequency can be established, so that:

$$Interval between inspections = \frac{TN\_wires}{FS} ,$$

where:
TN_wires is the estimated time to reach η_{adm} broken wires based on the rupture evolution curve, and FS is the safety factor.

In short, the present invention discloses a method for estimating the time between ruptures applicable to tensile armor wires that are components of flexible pipes by a fatigue mechanism, comprising:
receiving data on the flexible pipeline: operational history, annual fatigue damage, quantity of broken wires (ηᵢ) and maximum number of broken wires (η_{adm});
calculating, based on the data on the flexible pipe, by mathematical modeling, the curve of accumulated fatigue damage (AFD) vs % of broken wires;
calculating the time interval required for the number of broken wires to evolve from ηᵢ to η_{adm} (T_{N_wires}); and
defining the interval between inspections as:

$$Interval between inspections = \frac{TN\_wires}{FS} ,$$

where FS is a safety factor.

This makes it possible to reassess the viability of flexible pipes at level 3 and, eventually, promote an extension in their lifespan, reducing operational costs by avoiding unnecessary replacements.

1. A method for estimating time between wire ruptures applicable to tensile armor of flexible pipes by fatigue mechanism, the method comprising:
receiving data on the flexible pipe: operational history, annual fatigue damage, quantity of broken wires (ηᵢ) and maximum number of broken wires (η_{adm});
calculating, based on the data on the flexible pipe, by mathematical modeling, the curve of accumulated fatigue damage (AFD) vs % of broken wires;
calculating the time interval required for the number of broken wires to evolve from ηᵢ to η_{adm} (T_{N_wires}); and
defining the interval between inspections as:
$$Interval between inspections = \frac{TN\_wires}{FS} ,$$
where FS is a safety factor.

2. Method, according to claim 1, wherein the definition of the number of broken wires (ηᵢ) is made by inspection of the flexible pipe.

3. Method, according to claim 1, wherein the number of broken wires (ηᵢ) can be estimated from the rotation angle of the flexible pipe.

4. Method, according to claim 1, wherein the calculation of the time interval necessary for the number of broken wires to evolve from ηᵢ to η_{adm} (T_{N_wires}) comprises:
$${T}_{N \_ wires} = \frac{( AFD ( {η}_{adm} ) - AFD ( {η}_{i )} )}{AFD ( {η}_{i )} )} * \frac{{T}_{op}}{FS} * ( \frac{{\sum }_{1}^{n} {d}_{j} {T}_{j} / {T}_{op}}{{d}_{after inspection}} )$$
where:
Tₒₚ is the operating time until the inspection date, dⱼ is the annual damage with the respective stress curves (S-N) of each period (Tⱼ) before the inspection, d_{after inspection} is the annual damage with S-N curve after inspection, and FS is the safety factor.
